(19) United States
(12) Patent Application Publication
(10) Pub. No.: US 2024/0176359 A1
(43) Pub. Date: May 30, 2024

(54) METHOD FOR CONTROLLING AN UNMANNED AIRCRAFT

(71) Applicant: THALES, MEUDON (FR)

(72) Inventors: Guillaume HEREDIA, VALENCE (FR); Arthur MOUSSIERE, VALENCE (FR); Loïc CHACORNAC, VALENCE (FR); Nicolas MARTIN, VALENCE (FR); Paul DE COURCEL, VALENCE (FR)

(21) Appl. No.: 18/515,168

(22) Filed: Nov. 20, 2023

(30) Foreign Application Priority Data
Nov. 25, 2022 (FR) 2212330

(51) Int. Cl. G05D 1/04

(52) U.S. Cl. CPC G05D 1/042; B64U 2101/00

(57) ABSTRACT

A method for controlling an unmanned aircraft includes determining a maximum flying altitude for a ground position of the aircraft, the method comprising: for each point from a plurality of ground points situated within a perimeter around the ground position of the aircraft, referred to as “surrounding points”, determining one or more intersections between firstly a circle, the centre of which is the point and the radius of which is the maximum authorized ground distance at this point, referred to as the “determination circle”, and secondly a vertical related to the ground position of the aircraft, the circle being contained in a vertical plane comprising the vertical related to the ground position of the aircraft; and for all of the intersections thus obtained, selecting the greatest altitude as the maximum flying altitude.

### CROSS-REFERENCE TO RELATED APPLICATION

This application claims priority to foreign French patent application No. FR 2212330, filed on Nov. 25, 2022, the disclosure of which is incorporated by reference in its entirety.

### FIELD OF THE INVENTION

The invention relates to a method for controlling an unmanned aircraft comprising determining a maximum flying altitude authorized for a ground position of the aircraft. The invention also relates to an unmanned aircraft, in particular an aircraft of unmanned aeroplane type, comprising a control unit configured to implement the method according to the invention.

### BACKGROUND

An unmanned aeroplane (that is to say a fixed-wing aircraft) is called an “unmanned aerial vehicle” or “UAV” or, more generally, an “aerial drone”.

Flight regulations concerning aerial drones intended to join civil airspace include very stringent requirements for detection rates and avoiding all types of aircraft. Such regulations are defined by the European Union, among other things. The aim is to maintain a high level of safety for the navigation of all users of an airspace by avoiding collision risks.

Among other things, the European regulations demand separation of the airspace between unmanned aircraft and other aircraft. In particular, the European Union's implementing regulations (EU) 2019/947 and 2019/945 impose an airspace for unmanned aircraft operating in the “open” category. The authorized airspace is defined by a maximum authorized ground distance, for example 150 or 120 m. Ground distance is understood to mean the shortest distance between the unmanned aircraft and the ground. Ground distance does not necessarily coincide with height in relation to the ground, in other words the height according to a vertical. This is particularly true when the ground has a gradient. Thus, according to these regulations, unmanned aircraft operating in the open category must be at a distance of less than 120 m from the ground, for example. In reality, this definition authorizes a flying height vertically from the ground of greater than 120 m. For example, with a ground gradient of 45°, a maximum ground distance of 120 m allows a maximum vertical height of 170 m to be attained. The vertical limit, defined by this maximum vertical height, therefore changes with the gradient, allowing operations to be carried out close to cliffs, for example. Although the maximum ground distance may be constant over a flight route of an unmanned aircraft, the authorized vertical height can therefore vary according to the topology of the terrain, in particular its gradient.

Before they fly, some unmanned aircraft typically have to be the subject of a flight plan analysis that is declared to the authorities. Such an analysis is known particularly by the term SORA, for “Specific Operation Risk Assessment”. Among other things, it comprises the maximum authorized ground distances on this flight. The patent application publication FR3074347A1 describes the consideration of multiple parameters, in particular maximum ground distance, when an unmanned aircraft is flying. However, it does not describe how to determine the maximum vertical height authorized during the flight.

A method for determining the maximum vertical height authorized for an unmanned aircraft is known, however. FIG. 1 shows an explanatory diagram for this method. According to this method, the unmanned aircraft A knows a vertical flying limit L_{A} defined by a vertical height in relation to the ground S, the value of which is the maximum authorized ground distance H. Such a method has the advantage of being simple. However, in areas with steep gradients, the result of this is a difference h from the theoretical vertical limit L_{S} obtained as prescribed by the regulations. It is this theoretical limit L_{S}, or SORA limit, that is declared to the authorities. The vertical flying limit L_{A} obtained with the prior art method is then less than that authorized for the unmanned aircraft A. This may be particularly disadvantageous in that it reduces the airspace available to the unmanned aircraft A.

There is therefore a need for a method for controlling an unmanned aircraft that can be used to obtain, in flight, a maximum flying height that is as great as possible taking account of a maximum authorized ground distance.

### SUMMARY OF THE INVENTION

To this end, the invention proposes a method for controlling an unmanned aircraft comprising determining a maximum flying altitude for a ground position of the aircraft, said method comprising:
i. for each point from a plurality of ground points situated within a perimeter around the ground position of the aircraft, referred to as “surrounding points”, determining an intersection between firstly a circle, the centre of which is said point and the radius of which is the maximum authorized ground distance at this point, referred to as the “determination circle”, and secondly a vertical related to the ground position of the aircraft, the circle being contained in a vertical plane comprising said vertical related to the ground position of the aircraft, and
ii. for all of the intersections thus obtained, selecting the greatest altitude as the maximum flying altitude.

Courtesy of the method according to the invention, the maximum flying altitude is adjusted as closely as possible, according to the horizontal position of the unmanned aircraft. The method takes account of the maximum authorized ground distances at the points situated in the immediate vicinity of the aircraft. Thus, compared with the prior art, the method according to the invention allows a smaller difference from the theoretical vertical limit to be obtained, in particular in areas having a ground gradient. In the present application, the expression “ground position of the aircraft” denotes the vertical ground point of the aircraft.

According to one embodiment, horizontal positions of said surrounding points form a network of points, the centre of which is preferably a horizontal position of the aircraft.

According to one embodiment, the method comprises a step of identifying the surrounding points, said step involving selecting points situated within a horizontal distance D around the ground position of the aircraft, said points forming said surrounding points.

According to one variant, said horizontal distance D corresponds to the maximum authorized ground distance at said ground position of the aircraft, or to a difference between the maximum authorized ground distance at said ground position of the aircraft and a horizontal position uncertainty Hacc of the aircraft.

According to one variant, said step of identifying the surrounding points comprises selecting the points such that their horizontal positions are regularly aligned on concentric circles, referred to as “network circles”, centred around a horizontal position of the aircraft.

According to one variant, the horizontal positions of the surrounding points are aligned on a number n of network circles, the most eccentric network circle having a radius equal to said horizontal distance D, the distance d between the network circles being such that:

$$d = \frac{D}{n}$$

According to one embodiment, the method uses a digital map of a terrain intended to be overflown by said aircraft, said map comprising, for points on said terrain, referred to as “mapped points”, horizontal position data, an altitude datum and a datum regarding the maximum authorized ground distance at this point.

According to one variant, at least some of the surrounding points correspond to mapped points.

According to one variant, at least some of the surrounding points are situated between the mapped points, said method comprising a step of interpolating an altitude datum, and preferably a maximum authorized ground distance datum, at these points on the basis of the digital map.

According to one embodiment, said vertical passes through the ground position of the aircraft, or said vertical passes through a point determined by adding a horizontal position uncertainty to the horizontal distance between the surrounding point and the ground position of the aircraft.

According to one embodiment, the method is implemented while said aircraft is in flight, said ground position corresponding to a current position of the aircraft.

According to one embodiment, the ground position of the aircraft is obtained using an onboard receiver connected to a satellite navigation system.

According to one embodiment, the method is implemented by an electronic control unit aboard the aircraft.

The invention also relates to an unmanned aircraft, comprising an electronic control unit configured to implement a method as described above.

### BRIEF DESCRIPTION OF THE DRAWINGS

Other features and advantages of the present invention will become more apparent on reading the description that follows with reference to the following appended figures:

FIG. 1, which has already been described, illustrates a method according to the prior art;

FIG. 2 illustrates an exemplary method according to the invention;

FIG. 3 presents a schematic view of surrounding points used in an exemplary method according to the invention;

FIG. 4 shows a comparison between an exemplary method according to the invention and the method according to the prior art;

FIG. 5 presents a table illustrating the advantage of an exemplary method according to the invention over the prior art.

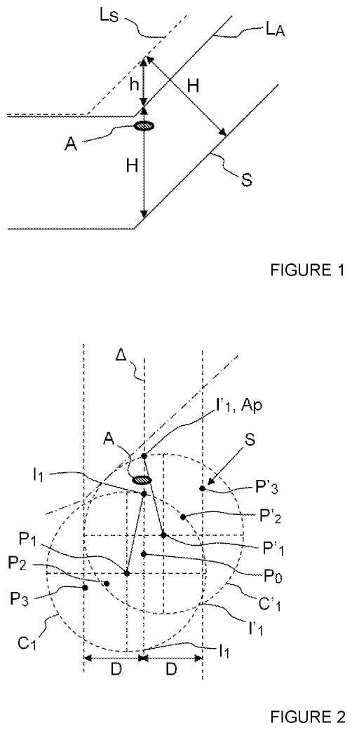

### DETAILED DESCRIPTION

An exemplary control method according to the invention will first be explained with reference to FIG. 2. When an unmanned aircraft A is flying above a ground S, the method can be used to determine a maximum flying altitude Ap for a ground position P₀ of the aircraft A. To this end, the steps of the method are in particular implemented by an electronic control unit. Such an electronic control unit comprises a processor, for example. The data used in the method are in particular digital data processed by the electronic control unit. The electronic control unit may be totally or partly situated on the ground. However, the electronic control unit is preferably aboard the aircraft A. The aircraft A may be equipped with an onboard receiver connected to a satellite navigation system in order to obtain the ground position P₀ of the aircraft A, in particular the horizontal position of the aircraft A.

The determination of the maximum flying altitude Ap for a ground position of the aircraft A may be implemented while the aircraft A is flying. Alternatively, this determination may be implemented prior to the aircraft A flying. In this case, the maximum flying altitudes Ap would be stored in a memory unit available to the aircraft A.

In the exemplary method, a plurality of ground points P₁, P₂, P₃, P′₁, P′₂, P′₃, referred to as “surrounding points”, situated within a perimeter around the ground position P₀ of the aircraft A are considered. The perimeter defines in particular an area immediately around the ground position P₀ of the aircraft A. To aid understanding, the explanation below is provided with reference to two surrounding points P₁, P′₁ situated on either side of the ground position P₀ of the aircraft A. Also to facilitate explanation, a first circle C₁ is drawn, the centre of which is a first surrounding point P₁ and the radius of which is the maximum authorized ground distance at the first surrounding point P₁. A second circle C′₁ is drawn, the centre of which is a second surrounding point P′₁, and the radius of which is the maximum authorized ground distance at the second surrounding point P′₁. The first C₁ and second C′₁ circles are contained in a vertical plane (here, the plane of the page) that comprises a vertical Δ passing through the ground position P₀ of the aircraft A. The first C₁ and second C′₁ circles are denoted by the expression “détermination circles”. The intersections I1 between the first circle C₁ and the vertical Δ are determined. Similarly, the intersections I′1 between the second circle C′₁ and the vertical Δ are determined. The greatest altitude among those of the intersections is selected as the maximum flying altitude Ap of the aircraft A for the ground position P₀. To simplify, only two determination circles C₁, C′₁ have been considered. In the method, however, the determination circles centred on the other surrounding points P₂, P₃, P′₂, P′₃ are also considered, including the determination circle centred on the ground position P₀ of the aircraft A. Moreover, in FIG. 2, only the surrounding points situated in a single vertical plane are illustrated; the method also uses surrounding points situated in other vertical planes containing the vertical Δ passing through the ground position P₀ of the aircraft A. The greatest altitude among the intersections is selected as the maximum flying altitude Ap at the ground position P₀ of the aircraft A.

In the prior art described above, the maximum flying altitude for a ground position P₀ of the aircraft A is determined by adding to the ground altitude a value of maximum authorized ground distance for this ground position P₀. In the method according to the invention, the maximum flying altitude at the ground position P₀ is determined by taking account of the local distinctive features of the terrain, such as the altitude of the surrounding points and the maximum authorized ground distance at these points.

The intersections I1, I′1 are in particular determined by geometric relationships between data regarding the horizontal position of the aircraft A and surrounding points, data regarding the altitude of the aircraft A and surrounding points and data regarding the maximum authorized ground distance at the surrounding points. The horizontal position of a point is understood to mean the position of the projection of the point onto a horizontal plane. For example, the altitude A of the intersection between the vertical Δ and a determination circle centred on a surrounding point P can be obtained using the following relationship:

A=\sqrt{H²−(PPo)²}+z

where:
A is the altitude of the intersection;
PP₀ is the horizontal distance between the ground position P₀ and the
   surrounding point P;
H is the maximum authorized ground distance at the surrounding point P;
z is the altitude of the surrounding point P.

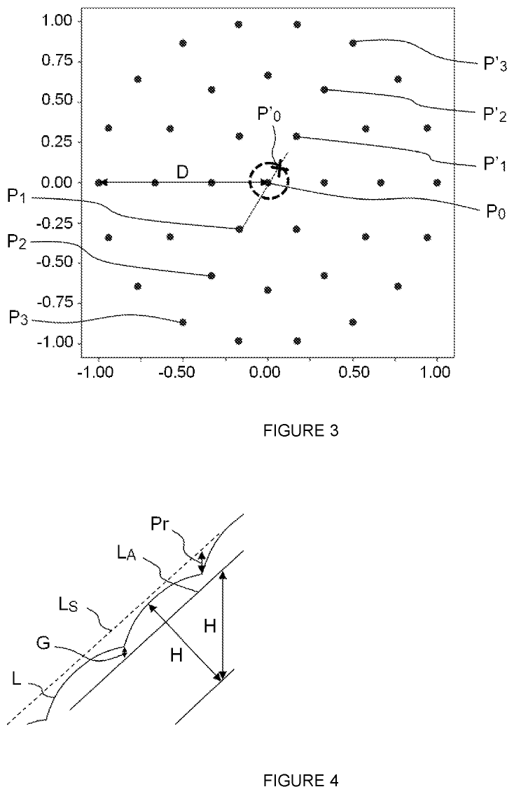

FIG. 3 shows a schematic view of the surrounding points from above. In this figure, the abscissae and ordinates are represented as values normalized in relation to the distance D defining the perimeter within which the surrounding points are situated. In particular, the surrounding points form a network of points within the perimeter around the ground position P₀ of the aircraft A. Such a network can be used to improve the precision of the method when determining the maximum flying altitude. Moreover, the network is preferably centred on the ground position P₀ of the aircraft A. This is particularly the case when the method is implemented in real time while the aircraft A is in flight.

The determination of the greatest altitude may be preceded by a step of identifying the surrounding points, in which the ground points situated within a horizontal distance D around the ground position P₀ of the aircraft A are selected, in order to properly take account of the surroundings close to the ground position P₀ of the aircraft A. This horizontal distance is particularly the maximum authorized ground distance H₀ at the ground position P₀ of the aircraft A. Such a distance H₀ is in particular defined in the flight plan of the aircraft A or in the SORA analysis or in a map of the ground. The distance H₀ may also be a value interpolated on the basis of a map of the ground. Using the maximum authorized ground distance H₀ at the ground position P₀ to determine the ground perimeter allows the approaches of obstacles or the appearance of gradient close to the aircraft A to be managed.

The horizontal distance D around the ground position P₀ of the aircraft A may also take account of a horizontal position uncertainty Hacc of the aircraft A, and thus improve the reliability of the method. The distance D is then such that:

D=H₀−Hacc

The determination of the intersections I1, I′1 between the determination circles C₁, C′₁ and the vertical Δ may then also take account of the horizontal position uncertainty Hacc of the aircraft A. As illustrated in FIG. 3 for the first surrounding point P₁, for example, a point P′₀ is determined by adding the horizontal position uncertainty Hacc to the horizontal distance between the first surrounding point P₁ and the ground position P₀ of the aircraft A. In other words, the point P′₀ is obtained by adding a horizontal position uncertainty to a distance ranging from the horizontal position of the surrounding point P₁ to that of the ground position P₀ of the aircraft A. The vertical Δ is shifted in order to pass through this determined point P′₀. Thus, the farthest possible ground position for the aircraft, in view of the horizontal position uncertainty Hacc, is taken into account. This point P′₀ is determined in a similar way for the other surrounding points. Thus, the altitude A of the intersection between a determination circle centred on a surrounding point P and the vertical Δ passing through the determined point P′₀ can be obtained using the following relationship:

A=\sqrt{H²−(PP₀+Hacc)²}+z

where:
A is the altitude of the intersection;
PP₀ is the horizontal distance between the ground position P₀ and the
   surrounding point P;
H is the maximum authorized ground distance at the surrounding point P;
z is the altitude of the surrounding point P;
Hacc is the horizontal position uncertainty of the aircraft A.

In this variant, the determination circles will therefore interact with different verticals in the vertical plane in which they are situated.

In particular, the surrounding points are chosen so that their horizontal positions are regularly aligned on concentric circles, referred to as “network circles”, centred around the horizontal position P₀ of the aircraft A. In particular, the surrounding points are moreover aligned on radial directions that are common to these network circles, as illustrated in FIG. 3, for example. Thus, the network of points is in particular a regular network centred on the ground position P₀ of the aircraft A. However, the network could be anything. In FIG. 3, the horizontal positions of the surrounding points are aligned on three network circles. The most eccentric network circle has a radius equal to the horizontal distance D defining the perimeter encompassing the surrounding points. The distance d between the network circles is equal to D/3. The number of network circles could be different from three, depending on the precision required for determining the maximum flying altitude at the ground position P₀ of the aircraft A or on the processing time permitted for such a determination.

Preferably, the method uses a digital map of the terrain (also called “digital terrain model”) intended to be overflown by the aircraft A. For points on the terrain, referred to as “mapped points”, the map comprises horizontal position data, an altitude datum and a datum regarding the maximum authorized ground distance at this point. These data are in particular digital data. Such a map is in particular aboard the aircraft A in a memory unit, in particular so as to be available to an electronic control unit aboard the aircraft A. The horizontal position data comprise in particular coordinates of the point in a horizontal plane.

When determining the maximum flying altitude at the ground position P₀ of the aircraft A, the method can use the mapped points as surrounding points. The method then uses the horizontal position data, the altitude datum and the datum regarding the maximum authorized ground distance at these mapped points. However, the precision of the method can be improved by choosing the surrounding points, as has been explained with reference to FIG. 3, for example. It is then not very likely that the identified surrounding points will correspond to the mapped points. The method then comprises a step of interpolating the altitude data and the data regarding the maximum authorized ground distance at these surrounding points, on the basis of the data for the mapped points around a respective surrounding point. The interpolation is in particular a bilinear interpolation. When the mapped points are used, uncertainties about the data can be taken into account, for example by subtracting from the altitude datum an uncertainty about the altitude before proceeding to the next steps.

Thus, an example of determination of a maximum flying altitude for a ground position P₀ of the aircraft A unfolds as follows. Map data aboard the aircraft A are read in order to carry out a bilinear interpolation of the altitude values, and in particular of the maximum authorized ground distance values, between the mapped points. To this end, an uncertainty about the map's altitude values is removed from the altitude values in order to take the worst case.

While flying, an electronic control unit determines the maximum flying altitude in real time, in particular at a rate chosen according to the speed of movement of the drone and in particular of between 20 and 100 ms. To this end, surrounding points around the ground position P₀ are identified within a distance D equal to the difference between the maximum authorized ground distance at the ground position P₀ of the aircraft A and a horizontal position uncertainty Hacc of the aircraft A. With a maximum authorized ground distance H of 150 m and a horizontal position uncertainty Hacc of 10 m, the distance D around the ground position P₀ of the aircraft A is equal to 140 m. The surrounding points are selected on network circles such that the most eccentric circle has a radius of 140 m. The concentric circles are 46.67 m apart. Next, the intersections between the determination circles and the vertical Δ passing through the ground position P₀ of the aircraft A are determined. The highest altitude among the intersections is selected as the maximum flying altitude at the ground position P₀ of the aircraft A.

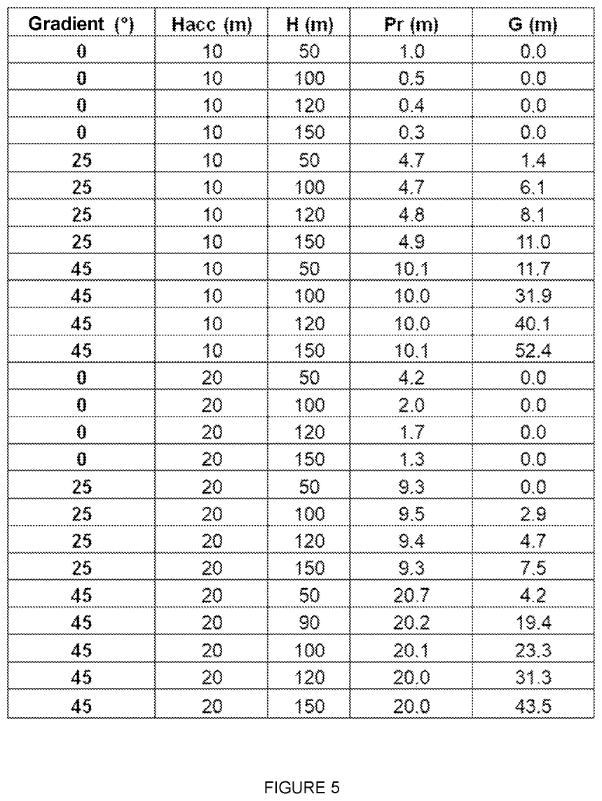

FIG. 4 shows a comparison between the vertical limit L obtained using the exemplary method, the theoretical vertical limit L_{S} and the vertical limit L_{A} obtained by simply adding the maximum authorized ground distance H to the altitude of the ground position of the aircraft A. It can be seen that, courtesy of the method, the vertical limit L of the aircraft A is closer to the theoretical vertical limit L_{S} than the vertical limit L_{A} obtained according to the prior art method. This can also be seen in the values in the table in FIG. 5, which presents parameters while the aircraft A is in exemplary flight. The table shows, from left to right, the gradient of the ground over the flight route, the horizontal position uncertainty Hacc of the aircraft A, the maximum authorized ground distance H, the difference Pr between the theoretical vertical limit and the vertical limit obtained using the method, and the difference G between the vertical limit obtained using the method and that obtained using the prior art method.

To simplify implementation of the method, the maximum authorized ground distance may be the same for all surrounding points. This is particularly the case when the flight route of the aircraft A is remote from high-risk areas, such as for example a military zone or an area close to an airport.

The method according to the invention is particularly advantageous for a flight above a ground having a steep gradient. The method is thus particularly advantageous for monitoring electrical lines or railways in mountainous areas. It is also particularly suitable when the horizontal position uncertainty Hacc of the aircraft A is less than the maximum authorized ground distance H. In particular, when the horizontal position uncertainty Hacc of the aircraft A is greater than the maximum authorized ground distance H, the vertical limit is determined by adding the maximum authorized ground distance H₀ to the altitude of the ground position P₀. Particularly, if this event takes place in flight above a ground having a steep gradient, the determination of the vertical limit takes into account in particular a maximum gradient over the flight route and the horizontal position uncertainty Hacc.

The present invention has been described with reference to particular examples. However, features may be omitted in an exemplary method according to the invention as defined by the claims.

1. A method for controlling an unmanned aircraft (A), implemented by an electronic control unit, comprising determining a maximum flying altitude (Ap) for a ground position (P₀) of the aircraft, said method comprising:
i. for each point from a plurality of ground points (P₀, P₁, P₂, P₃, P′₁, P′₂, P′₃) situated within a perimeter around the ground position (P₀) of the aircraft, referred to as “surrounding points”, determining one or more intersections (I1, I′1) between firstly a circle (C₁, C′₁), the centre of which is said point and the radius of which is the maximum authorized ground distance (H) at this point, referred to as the “determination circle”, and secondly a vertical (Δ) related to the ground position (P₀) of the aircraft, the circle (C₁, C′₁) being contained in a vertical plane comprising said vertical (Δ) related to the ground position (P₀) of the aircraft, and
ii. for all of the intersections (I1, I′1) thus obtained, selecting the greatest altitude as the maximum flying altitude (Ap).

2. The method according to claim 1, wherein horizontal positions of said surrounding points (P₀, P₁, P₂, P₃, P′₁, P′₂, P′₃) form a network of points, the centre of which is preferably a horizontal position of the aircraft (A).

3. The method according to claim 1, comprising a step of identifying the surrounding points (P₀, P₁, P₂, P₃, P′₁, P′₂, P′₃), said step involving selecting points situated within a horizontal distance D around the ground position (P₀) of the aircraft, said points forming said surrounding points.

4. The method according to claim 3, wherein said horizontal distance D corresponds to the maximum authorized ground distance at said ground position (P₀) of the aircraft, or to a difference between the maximum authorized ground distance at said ground position (P₀) of the aircraft and a horizontal position uncertainty Hacc of the aircraft.

5. The method according to claim 3, wherein said step of identifying the surrounding points (P₀, P₁, P₂, P₃, P′₁, P′₂, P′₃) comprises selecting the points such that their horizontal positions are regularly aligned on concentric circles, referred to as “network circles”, centred around a horizontal position of the aircraft.

6. The method according to claim 4, wherein the horizontal positions of the surrounding points (P₀, P₁, P₂, P₃, P′₁, P′₂, P′₃) are aligned on a number n of network circles, the most eccentric network circle having a radius equal to said horizontal distance D, the distance d between the network circles being such that:
$$d = \frac{D}{n} .$$

7. The method according to claim 1, using a digital map of a terrain intended to be overflown by said aircraft (A), said map comprising, for points on said terrain, referred to as “mapped points”, horizontal position data, an altitude datum and a datum regarding the maximum authorized ground distance (H) at this point.

8. The method according to claim 7, wherein at least some of the surrounding points (P₀, P₁, P₂, P₃, P′₁, P′₂, P′₃) correspond to mapped points.

9. The method according to claim 7, wherein at least some of the surrounding points (P₀, P₁, P₂, P₃, P′₁, P′₂, P′₃) are situated between the mapped points, said method comprising a step of interpolating an altitude datum, and preferably a maximum authorized ground distance datum, at these points on the basis of the digital map.

10. The method according to claim 1, wherein said vertical passes through the ground position (P₀) of the aircraft, or said vertical (Δ) passes through a point (P′₀) determined by adding a horizontal position uncertainty Hacc to the horizontal distance between the surrounding point and the ground position (P₀) of the aircraft.

11. The method according to claim 1, implemented while said aircraft (A) is in flight, said ground position corresponding to a current position of the aircraft.

12. The method according to claim 1, wherein the ground position of the aircraft is obtained using an onboard receiver connected to a satellite navigation system.

13. The method according to claim 1, implemented by an electronic control unit aboard the aircraft (A).

14. An unmanned aircraft (A), comprising an electronic control unit configured to implement a method according to claim 1.
